(19) United States
(12) Patent Application Publication
(10) Pub. No.: US 2002/0104888 A1
(43) Pub. Date: Aug. 8, 2002

(54) Systems and methods for an encoded information reader

(76) Inventors: Ralph E. Simon, Cupertino, CA (US); Thierry Hernoult, Cupertino, CA (US); Livio Lascu, Sunnyvale, CA (US); Spiro Zefferys, Glendale, AZ (US); David Silverglate, Santa Cruz, CA (US)

Correspondence Address: RAHUL ENGINEER, Skjerven Morrill MacPherson, 3 Embarcadero Center, Suite 2800, San Francisco, CA, 94111, US

(21) Appl. No.: 09/816,741

(22) Filed: Mar. 22, 2001

Related U.S. Application Data
(60) Provisional application No. 60/191,692, filed on Mar. 23, 2000.

(51) Int. Cl. G06K 7/10

(52) U.S. Cl. 235/472.03

(57) ABSTRACT

A system for reading encoded information includes a housing that has an aperture formed therein, a radiation source mounted within the housing that is used for emitting radiation through the aperture, and a radiation detector mounted within the housing that is used to receive radiation reflected back through the aperture. The radiation source can be an infrared light-emitting diode (LED), and the radiation detector can be a semiconductor sensor.

A method for reading encoded information includes emitting infrared light onto the encoded information, receiving the infrared light that has been reflected off the encoded information, and producing an electrical signal that represents the received infrared light.

### CROSS REFERENCE TO RELATED APPLICATION

This patent application claims the benefit of the filing date of U.S. provisional application Ser. No. 60/191,692, filed Mar. 23, 2000.

### BACKGROUND

1. Field of the Invention

The invention relates generally to the field of encoded information readers, and more particularly, to systems and methods for encoded information readers using infrared light.

2. Background Information

Modern techniques for retrieving data regarding a product often involve the use of a bar code, a bar code scanner, and a computer system. The bar code is generally affixed to the product and uniquely identifies the product. The bar code scanner is then used to scan the bar code (i.e. “read” the bar code), and this information is passed to the computer system which can match the product's unique bar code to a database storing other information associated with the product. This information can include the price of the product, the quantity remaining of that product in the merchant's stock, the size of the product, the version of the product (e.g. the color, flavor, scent, etc.), and any other information that the merchant or a consumer can find helpful.

Bar code scanners typically use a laser beam to scan the bar code on a product. The use of a laser permits a large depth of field and high accuracy when reading a bar code. This laser light is reflected off the bar code, and bar code scanners generally use photocell detectors to detect this reflected laser light. It is through this detection of reflected laser light that bar code scanners can “read” bar codes. As the reflected laser light is detected by the photocell, the photocell can generate an electrical signal representative of the bar code. This electrical signal can then be passed to the computer system where it is used to identify the product and retrieve the associated information.

Bar code scanners have their limitations. One important limitation is cost. Laser sources are expensive and therefore bar code scanners using lasers tend to be expensive as well. Another limitation is that photocells are not sensitive to weak radiation signals, which is one reason laser radiation must be used in bar code scanners instead of alternative, weaker sources of radiation. Accordingly, there is a need for a lost cost alternative to laser bar code scanners that still produces highly accurate results.

### SUMMARY OF THE PREFERRED EMBODIMENTS

The disadvantages and problems associated with reading encoded information have been substantially reduced or eliminated using the present invention, which provides a low cost alternative to known encoded information readers.

In accordance with an embodiment of the invention, a system for reading encoded information includes a housing that has an aperture formed therein, a radiation source mounted within the housing that is used for emitting radiation through the aperture, and a radiation detector mounted within the housing that is used to receive radiation reflected back through the aperture. The radiation source can be an infrared light-emitting diode (LED), and the radiation detector can be a semiconductor sensor.

In accordance with another embodiment of the invention, a method for reading encoded information includes emitting infrared light onto the encoded information, receiving the infrared light that has been reflected off the encoded information, and producing an electrical signal that represents the received infrared light. In other embodiments, the emitted infrared light can be focused onto the encoded information, or the infrared light that has reflected off the encoded information can be focused onto the radiation detector, or both.

An important technical advantage of the present invention includes using an LED in conjunction with a semiconductor detector. This provides a high resolution reader for encoded information (e.g., bar codes) which can be easily manufactured at a relatively low cost. Other important technical advantages of the present invention are readily apparent to one skilled in the art from the following figures, descriptions, and claims.

### BRIEF DESCRIPTION OF THE DRAWINGS

For a more complete understanding of the present invention and for further features and advantages, reference is now made to the following description taken in conjunction with the accompanying drawings, in which:

FIG. 1 illustrates a system for reading encoded information, according to an embodiment of the invention, situated over a piece of encoded information.

FIG. 2 illustrates a system for reading encoded information, according to another embodiment of the invention.

FIG. 3 illustrates a system for reading encoded information, according to yet another embodiment of the invention.

FIG. 4 illustrates a system for reading encoded information, according to still another embodiment of the invention, situated over a piece of encoded information.

FIG. 5 illustrates a system for reading encoded information, according to still yet another embodiment of the invention, situated over a piece of encoded information.

FIG. 6 illustrates a system for reading encoded information, according to yet another embodiment of the invention, situated over a piece of encoded information.

### DETAILED DESCRIPTION OF THE PREFERRED EMBODIMENTS

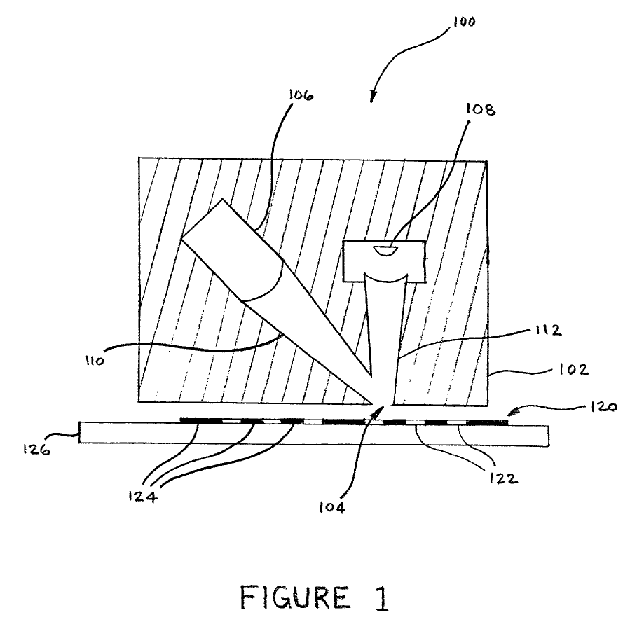

The preferred embodiments of the present invention and their advantages are best understood by referring to FIGS. 1 through 6 of the drawings. Like numerals are used for like and corresponding parts of the various drawings.

FIG. 1 illustrates an encoded information reader 100, according to one embodiment of the invention, situated over a piece of encoded information 120. As will be explained in further detail below, reader 100 “reads” encoded information 120 by emitting radiation at encoded information 120, and then detecting the reflected radiation. Reader 100 then generates an electrical signal that is representative of encoded information 120.

Reader 100 consists of a housing 102 that has at least one aperture 104 formed therein. Mounted within housing 102 are a radiation source 106 and a radiation detector 108. Radiation source 106 can emit radiation through aperture 104 at encoded information 120, and radiation detector 108 can detect radiation that is reflected off encoded information 120. A channel 110 is provided within housing 102 to permit radiation emitted from radiation source 106 to exit through aperture 104, and a channel 112 is provided to permit radiation reflected back into aperture 104 to reach radiation detector 108.

Encoded information 120 is generally a pattern that can be read by reader 100. In one embodiment, encoded information 120 can comprise a pattern with reflecting and non-reflecting components, such as white bars 122 and black bars 124. White bars 122 tend to reflect a relatively large amount of the emitted radiation back to radiation detector 108, while black bars 124 tend to absorb a relatively large amount of the emitted radiation and thus do not reflect a large amount of the emitted radiation back to radiation detector 108. The relative reflectivity of white bars 122 to black bars 124 effects the sensitivity of radiation detector 108 to encoded information 120, and therefore it is preferred to have a strong contrast between the two. The size of the bars can vary, and in one embodiment they can range from zero to ten mils. A typical bar code or a universal product code (UPC) code is an example of a pattern with reflecting and non-reflecting components. In other embodiments, encoded information 120 can be in the form of objects or shapes that are not simply black and white bars. Encoded information 120 is generally located on a card 126 or some other relatively flat surface.

According to an embodiment of the invention, housing 102 can take the form of a box-like structure, as shown in FIG. 1. Because stray radiation reaching radiation detector 108 can effect its sensitivity, the walls of housing 102 can be formed, coated, or lined at least in part by a radiation absorbing material, such as any material that is black or some other dark color. This especially includes the areas of housing 102 that form aperture 104 and channels 110 and 112. The interior regions of housing 102, in particular the walls of channels 110 and 112, can also be angled to minimize radiation reflected off the walls from reaching detector 108.

In other embodiments, housing 102 can take different forms, such as a pen-shaped or wand-shaped form, or a gun-shaped form. Housing 102 can also include a support element (not shown) to hold encoded information 120 in close proximity to aperture 104 as it is being read. If housing 102 cannot provide a support element, another mechanical assembly for encoded information reader 100 can be included to provide this functionality.

According to an embodiment of the invention, aperture 104 can be a narrow slit formed in housing 102. The width of aperture 104 defines the resolution of the system. The narrower the width of aperture 104, the finer the resolution will be, thereby allowing reader 100 to read narrower black and white bars of encoded information 120. A wider aperture 104 will generally limit reader 100 to encoded information 120 having wider black and white bars. In other embodiments, aperture 104 can be formed in alternate shapes, including but not limited to round, oval, square, or rectangular apertures. When encoded information 120 is made up of patterns other than black and white bars, the ability of reader 100 to detect small features of the pattern will depend on the size and shape of aperture 104. So the physical configuration of aperture 104 will effect what types of encoded information are readable.

In accordance with an embodiment of the invention, radiation source 106 is mounted within housing 102 and is generally used to emit radiation onto encoded information 120. This emitted radiation travels down channel 110 and exits through aperture 104, where it can strike encoded information 120. Radiation source 106 is typically a light source, and in particular, can be an infrared light source. In an embodiment, an infrared light emitting diode (LED) can be used to provide the infrared light source. To minimize radiation which may result from striking surfaces of housing 102 as the radiation exits through aperture 104, in another embodiment, the LED used can be shaped to produce an image of an emitting chip and cup into the aperture.

In still other embodiments, an objective can be used in conjunction with radiation source 106 to focus the emitted radiation. The objective can be part of the radiation source, such as an LED that has a built-in focusing means, or it can be separate from radiation source 106. The use of an objective to focus emitted radiation increases the amount of radiation exiting through aperture 104, and minimizes the scattering of radiation off the interior surfaces of housing 102 and off the edges of aperture 104.

According to an embodiment of the invention, radiation detector 108 is also mounted within housing 102 and is generally used for sensing radiation emitted from radiation source 106 that has been reflected off encoded information 120. This reflected radiation reaches radiation detector 108 by entering through aperture 104 and then traveling up channel 112. By detecting this reflected radiation, radiation detector 108 can “see” encoded information 120, thus allowing encoded information reader 100 to “read” the same. Radiation detector 108 can then generate electrical signals representing encoded information 120. Typically, strong electrical signals are generated by radiation detector 108 when relatively large amounts of reflected radiation are received (i.e. when white bars 122 are positioned at aperture 104), and weak electrical signals are generated when relatively low amounts of reflected radiation are received (i.e. when black bars 124 are positioned at aperture 104). In one embodiment of the invention, radiation detector 108 is a light sensor, and in particular a semiconductor infrared light sensor, used to detect infrared light that has been reflected off encoded information 120. Various devices that can perform the functions of radiation detector 108 include but are not limited to photodiodes, transistors, Darlington transistors, or photo integrated circuits.

Radiation detector 108 can be mounted within housing 102 in different configurations. For example, radiation detector 108 can be placed in an axial or a sidelooker geometry relative to radiation source 106. Radiation detector 108 can also be placed in close proximity to aperture 104 to collect reflected radiation over a wider solid angle from aperture 104 than would be collected if radiation detector 108 was farther away. The collection of reflected radiation over a wider solid angle also tends to increase the amount of radiation collected off white bars 122 relative to that collected off black bars 124, thereby increasing the sensitivity of radiation detector 108. Radiation detector 108 can also be positioned within housing 102 to avoid certain types of reflected radiation, such as specularly reflected radiation, and to collect other types of reflected radiation, such as diffusely reflected radiation.

Encoded information reader 100 typically operates by having encoded information 120 pass below aperture 104 as radiation is emitted from radiation source 106. Alternately, reader 100 can pass over stationary encoded information 120. As encoded information 120 passes below aperture 104, every appearance of a white bar 122 below aperture 104 tends to result in the reflection of a large amount of the emitted radiation back to radiation detector 108, causing radiation detector 108 to generate strong electrical signals at those moments. And every appearance of a black bar 124 below aperture 104 tends to result in the absorption of a large amount of the emitted radiation, causing radiation detector 108 to generate weak electrical signals at those moments. Thus the overall electrical signal pattern produced by radiation detector 108 is a combination of strong and weak signals, which is an electrical representation of encoded information 120.

The amount of reflected radiation reaching radiation detector 108 can be increased by maintaining encoded information 120 in close proximity to aperture 104, thereby causing more reflected radiation to enter aperture 104. As noted above, this can be done through the use of a support element that can hold encoded information 120 close to aperture 104. This increase in reflected radiation also tends to increase the sensitivity of radiation detector 108 because the reflected radiation off white bars 122 can now generate a much stronger signal, resulting in a greater differential between the signals for white bars 122 and black bars 124.

When emitted radiation from radiation source 106 strikes encoded information 120, the resulting reflected radiation generally has both a specularly reflected component and a diffusely reflected component. The specularly reflected component is typically a strong component (it generally carries a significant portion of the energy from the emitted radiation) and reflects off encoded information 120 at an angle of reflection that is equal to the angle of incidence for the emitted radiation. The diffusely reflected component, on the other hand, is spread out over a range of angles. The energy contained in the diffusely reflected component is likewise spread out, therefore any particular ray of the diffusely reflected component will be relatively weak. The diffusely reflected component is also referred to as scattered radiation.

In an embodiment of the invention, the use of diffusely reflected radiation is preferred over the use of specularly reflected radiation. This is due at least in part to the fact that many black inks used in printing black bars 124 tend to have a significant specular reflection component. Because the sensitivity of radiation detector 108 depends on minimizing the amount of reflected radiation coming off black bars 124 while maximizing the amount coming off white bars 122, the presence of a significant specularly reflected radiation component coming off black bars 124 is undesirable. Therefore, rejecting the specular component of the reflected radiation is preferred, and as noted above, can be done by strategically placing radiation detector 108 within housing 102 so that the specular component of the reflected radiation is avoided.

In other embodiments, the specular component of the reflected radiation can be used by radiation detector 108, either with or without the use the diffusely reflected component. The use of different types of patterns for encoded information 120, as well as the use of different colors or materials, can make the use of the specularly reflected radiation more desirable.

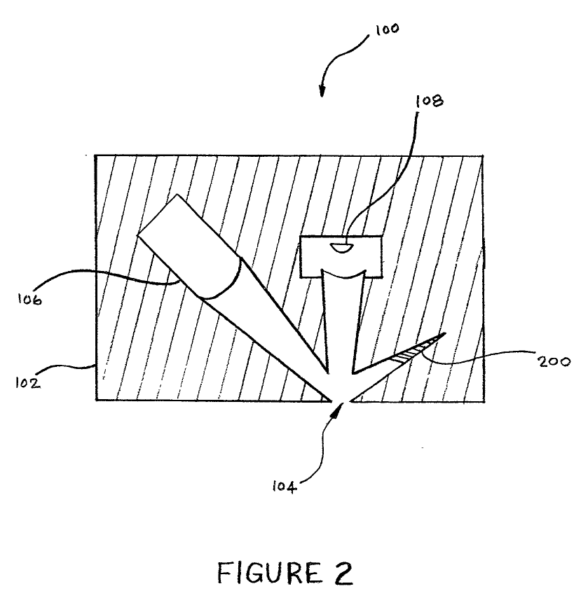

FIG. 2 illustrates an encoded information reader 100, in accordance with another embodiment of the invention. Here a light trap 200 is mounted within housing 102 to aid in minimizing stray radiation from reaching detector 108. Light trap 200 can be positioned to capture specularly reflected radiation off encoded information 120 either before it can directly reach radiation detector 108, or before it can generate scattered radiation that makes its way to radiation detector 108. This is another method of preventing specularly reflected radiation from reaching radiation detector 108.

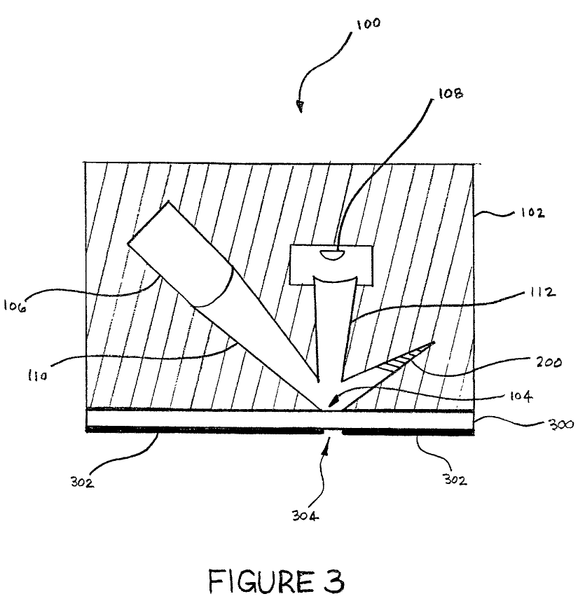

FIG. 3 illustrates yet another embodiment of the invention in which a dust cover 300 is mounted to housing 102 proximal to aperture 104. Dust cover 300 prevents particles from entering housing 102. The presence of particles within housing 102 can result in unwanted scattered radiation; therefore, maintaining the interior of housing 102 particle-free is important. Dust cover 300 can have non-transparent portions 302 and a transparent portion 304. Radiation can travel into and out of housing 102 through transparent portion 304. Because of this, transparent portion 304 now becomes the defining aperture of reader 100. In an embodiment, transparent portion 304 can be in the form of a narrow slit. In other embodiments, transparent portion 304 can take on other forms such as round, square, or rectangular shapes. In yet another embodiment, the entire dust cover 300 can be transparent and aperture 104 can remain the defining aperture of reader 100. Typically, dust cover 300 is formed at least in part out of glass or plastic.

When radiation is emitted by radiation source 106, a portion of the emitted radiation will generally reflect off dust cover 300 back into housing 102 as specularly reflected radiation. To capture this specular radiation and prevent it from interfering with radiation detector 108, light trap 200 is provided in an embodiment of the invention. The walls of channels 110 and 112 can also aid in absorbing any radiation reflected back into housing 102 by dust cover 300 provided that they are formed of or coated with a radiation absorbing material.

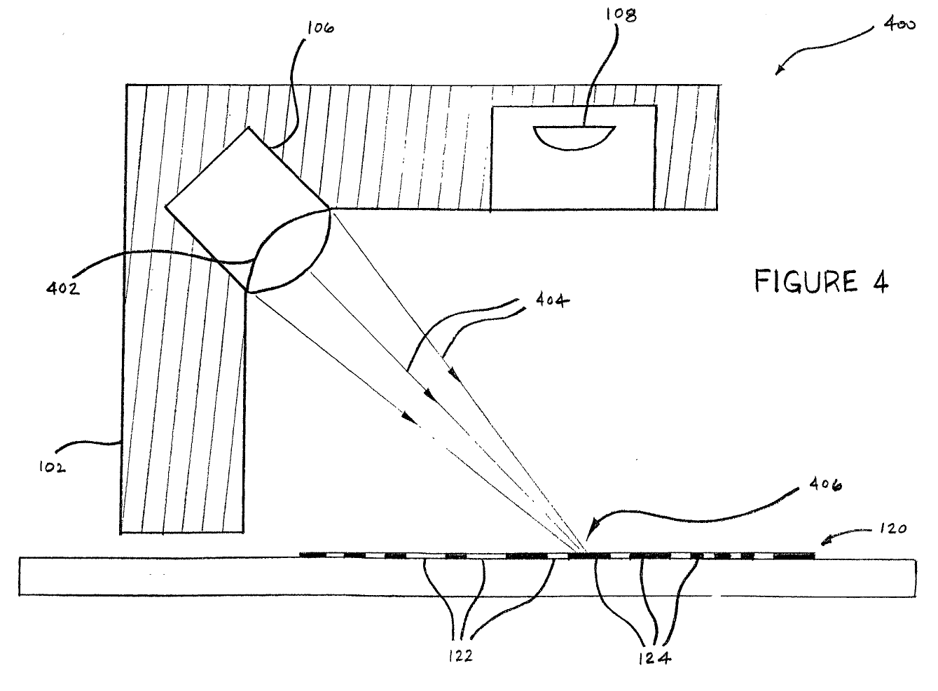

FIG. 4 illustrates another embodiment of the invention where an encoded information reader 400 includes an objective 402 to focus the radiation emitted from radiation source 106. In FIG. 4, the emitted radiation is represented by emitted radiation rays 404. Objective 402 focuses these emitted radiation rays 404 onto a small illuminated region 406 on encoded information 120. This configuration eliminates the need for an aperture in the system, which is why housing 102 does not have an aperture in this embodiment. Housing 102 is used here primarily to hold radiation source 106, objective 402, and radiation detector 108 in proper alignment, and to substantially prevent external light from reaching radiation detector 108.

In the embodiment of FIG. 4, radiation detector 108 collects radiation that is reflected off illuminated region 406 as encoded information 120 passes below reader 100 (or as reader 100 passes over encoded information 120). In an embodiment, region 406 is smaller than the width of any of white bars 122 or black bars 124 that make up encoded information 120. Therefore at any given moment, illuminated region 406 is illuminating either a reflective region (i.e. region 406 is on one of white bars 122) or a non-reflective region (i.e. region 406 is on one of black bars 124). Thus radiation detector 108 will either “see” a bright spot or a dark spot. So as encoded information passes below reader 100, radiation detector 108 can generate an electrical signal representing these bright and dark spots that it detects.

In another embodiment of the invention, a support element can be included as part of housing 102, or as a separate mechanism from housing 102, to keep encoded information 120 within a certain distance of radiation source 106 and radiation detector 108. This can be particularly advantageous in the embodiment of FIG. 4 because focusing LEDs tend to have a limited depth of field. Therefore maintaining encoded information 120 within a proper distance from reader 100, and being able to control this distance, is desirable.

In an embodiment of the invention, objective 402 can be implemented as a Cartesian Ovoid lens that focuses emitted radiation from radiation source 106 to illuminated region 406 on encoded information 120. In this or another embodiment, radiation source 106 can be an LED that has only a top surface of the LED focused onto encoded information 120, thereby producing a relatively small illuminated region 406. In yet another embodiment, a long LED can be used as radiation source 106. In this embodiment, the long LED can produce a demagnified image of a radiation source. For example, if the source is 10 mils by 10 mils, an LED with a magnification of one-half will produce an illuminated region 406 that is 5 mils by 5 mils. In other embodiments, other lenses can be used in place of a Cartesian Ovoid lens.

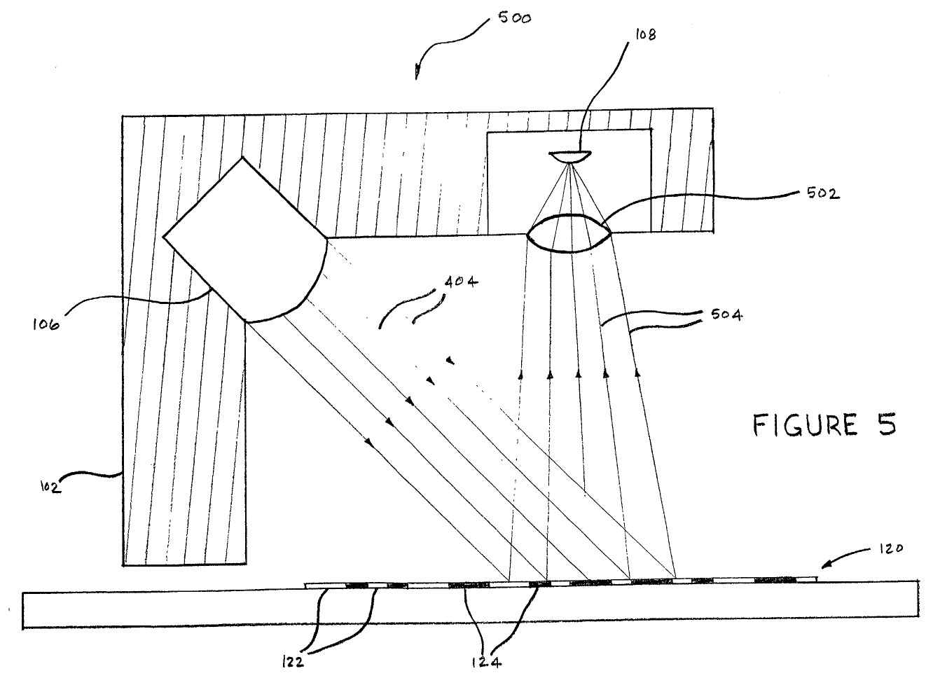

FIG. 5 illustrates an encoded information reader 500 where an objective 502 is used in conjunction with radiation detector 108. Objective 502 collects and then focuses reflected radiation rays 504 onto radiation detector 108, thereby producing an image of encoded information 120 directly on radiation detector 108. So as encoded information 120 passes below reader 500 (or as reader 500 passes over encoded information 120), an image of encoded information 120 passes across radiation detector 108. This image passing over radiation detector 108 causes radiation detector 108 to generate an electrical signal representative of the image. Therefore, as with the system of FIG. 4, reader 500 does not require an aperture formed in housing 102.

The use of objective 502 to produce a focused image on radiation detector 108 increases the resolution of reader 500. For example, if a detection area on radiation detector 108 is 10 mils wide, and the image of encoded information 120 is magnified to two times, the effective detection area of radiation detector 108 will be 5 mils wide. Different types of lenses can be used in reader 500 as objective 502, and in an embodiment a Cartesian Ovoid lens is used.

Unlike the systems shown in FIGS. 1 to 4, reader 500 of FIG. 5 is not designed to maximize collection of reflected radiation. Rather, objective 502 is used in reader 500 to produce an image of encoded information 120 directly on radiation detector 108. The use of objective 502 also tends to prevent stray radiation from reaching radiation detector 108 because stray radiation is not properly focused by objective 502 onto radiation detector 108. This feature makes reader 500 relatively insensitive to stray radiation.

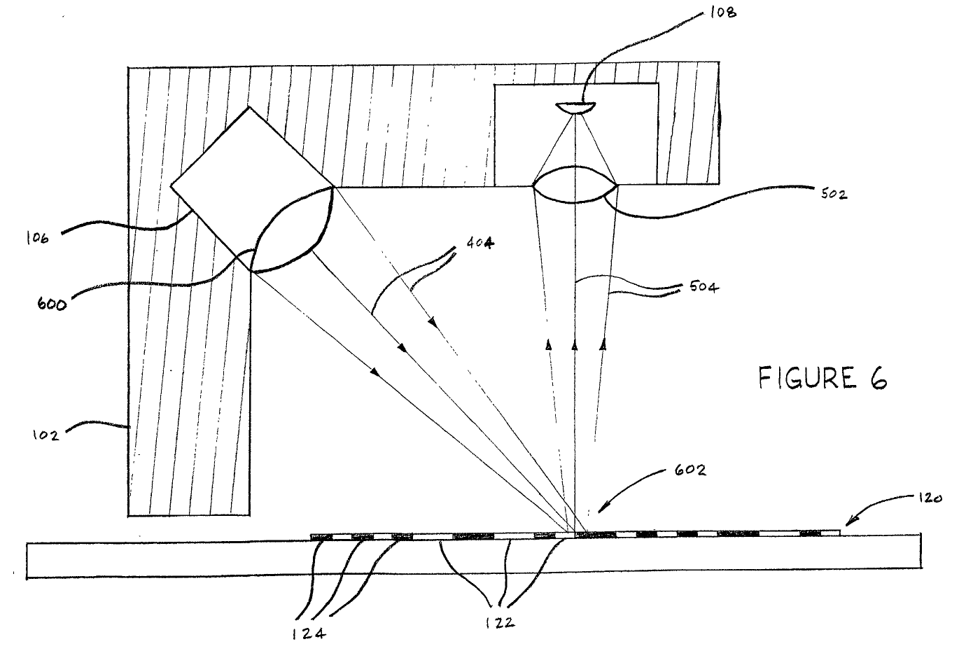

In the embodiment of FIG. 5, radiation source 106 can simply comprise an LED. In other embodiments, an objective can be provided with radiation source 106 to produce a small illuminated region on encoded information 120. This is shown in FIG. 6 where an objective 600 is used with radiation source 106, thus producing a small illuminated region 602 on encoded information 120. According to an embodiment of the invention, objective 600 can be provided by a Cartesian Ovoid lens, although other lenses may also be used with this system.

Turning back to FIG. 5, according to an embodiment of reader 500, radiation detector 108 can have a small detection area. The small detection area of radiation detector 108 can be provided by using a small area chip, or by placing a mask with a small aperture over radiation detector 108. In other embodiments, alternative methods of providing a small detection area can be used.

Housing 102 of reader 500 is configured to hold radiation source 106 and radiation detector 108 in proper alignment such that emitted radiation from radiation source 106 is reflected onto objective 502. As mentioned above, housing 102 does not include an aperture in this embodiment. Housing 102 can also include a support element to maintain encoded information 120 in a proper plane as required by objective 502 for proper focusing, or a separate mechanism can be included to provide this support element.

In alternate embodiments of the invention, two or more readers such as those described in FIGS. 1 to 6 can be constructed together (e.g. in parallel) and used simultaneously. This allows for two or more pieces of encoded information 120 to be read at the same time. For example, because the systems described herein can be used manually, the transit time of a reader moving across encoded information 120 (or the transit time for encoded information 120 to pass below a reader) will not be uniform. Therefore, a timing pattern may be included with encoded information 120, and the reader will therefore have to detect two patterns simultaneously. Thus a device built with two readers in parallel would be useful to read a timing pattern and encoded information 120 simultaneously.

If two or more readers are constructed together, in some embodiments one radiation source 106 can be used to provided emitted radiation for two or more radiation detectors 108. In these embodiments, a radiation source 106 that produces an extended illuminated region would be preferable.

Accordingly, systems and methods of the present invention have been described for providing a low cost, easily manufactured encoded information reader. While various embodiments of the invention have been shown and described, it will be apparent to those skilled in the art that numerous alterations may be made without departing from the inventive concepts presented herein. Thus, the invention is not to be limited except in accordance with the following claims and their equivalents.

What is claimed is:

1. A system for reading encoded information, comprising:
a housing having an aperture formed therein;
a radiation source mounted within the housing and operable to emit radiation through the aperture; and
a radiation detector mounted within the housing and operable to receive radiation reflected back through the aperture.

2. The system of claim 1, wherein the radiation source comprises a light-emitting diode.

3. The system of claim 1, wherein the radiation source comprises an infrared light source.

4. The system of claim 1, wherein the radiation detector comprises a semiconductor sensor.

5. The system of claim 1, wherein the radiation detector is operable to generate an electrical signal representative of the radiation reflected back through.

6. The system of claim 1, wherein the radiation detector is mounted in closer proximity to the aperture than the radiation source.

7. The system of claim 1, wherein the radiation detector is mounted to receive diffusely reflected radiation and to avoid specularly reflected radiation.

8. The system of claim 1, wherein the aperture is a slit.

9. The system of claim 1, wherein the housing is in the shape of a pen.

10. The system of claim 1, wherein interior surfaces of the housing are operable to absorb radiation.

11. The system of claim 1, wherein the interior surfaces of the housing have a non-reflective surface.

12. The system of claim 1, wherein exterior surfaces of the housing are operable to absorb radiation.

13. The system of claim 1, wherein the encoded information comprises a pattern having reflecting components and non-reflecting components.

14. The system of claim 13, wherein the pattern is provided on a substantially flat surface.

15. The system of claim 1, further comprising a light trap formed in the housing and operable to collect specularly reflected radiation.

16. The system of claim 1, further comprising a cover attached to the housing and positioned over the aperture, wherein a portion of the cover directly adjacent to the aperture is transparent.

17. The system of claim 1, further comprising a support element to maintain the encoded information in close proximity to the aperture.

18. The system of claim 2, wherein the light-emitting diode is shaped to produce an image of an emitting chip and cup in the aperture.

19. The system of claim 4, wherein the semiconductor sensor comprises a photodiode.

20. The system of claim 4, wherein the semiconductor sensor comprises a transistor.

21. The system of claim 4, wherein the semiconductor sensor comprises a Darlington transistor.

22. The system of claim 4, wherein the semiconductor sensor comprises a photo integrated circuit.

23. The system of claim 13, wherein the pattern comprises a bar code.

24. The system of claim 13, wherein the pattern comprises a Universal Product Code.

25. The system of claim 16, wherein the cover is formed at least in part of glass.

26. The system of claim 16, wherein the cover is formed at least in part of plastic.

27. The system of claim 16, wherein portions of the cover that are not directly adjacent to the aperture are not transparent.

28. The system of claim 16, wherein the entire cover is transparent.

29. A system for reading encoded information, comprising:
a housing;
a radiation source mounted within the housing and operable to emit radiation;
a lens operable to focus the radiation emitted from the radiation source onto the encoded information; and
a radiation detector mounted within the housing and operable to receive radiation reflected by the encoded information.

30. The system of claim 29, wherein the radiation source is a light-emitting diode.

31. The system of claim 29, wherein the radiation detector comprises a semiconductor sensor.

32. The system of claim 29, wherein the lens comprises a Cartesian Ovoid lens.

33. The system of claim 29, wherein the lens is located within the housing.

34. The system of claim 29, wherein the encoded information comprises a pattern having reflecting and non-reflecting components.

35. The system of claim 30, wherein the light-emitting diode comprises an emitter chip having a top surface which is focused by the lens.

36. The system of claim 30, wherein the light-emitting diode comprises a long light-emitting diode operable to produce a demagnified image.

37. The system of claim 31, wherein the semiconductor sensor comprises a photodiode.

38. The system of claim 31, wherein the semiconductor sensor comprises a transistor.

39. The system of claim 31, wherein the semiconductor sensor comprises a Darlington transistor.

40. The system of claim 31, wherein the semiconductor sensor comprises a photo integrated circuit.

41. A system for reading encoded information, comprising:
a housing;
a radiation source mounted within the housing and operable to emit radiation onto the encoded information;
a radiation detector mounted within the housing; and
a lens operable to focus radiation reflected by the encoded information onto the detector.

42. The system of claim 41, wherein the radiation source is a light-emitting diode.

43. The system of claim 41, wherein the radiation detector comprises a semiconductor sensor.

44. The system of claim 41, wherein the lens comprises a Cartesian Ovoid lens.

45. The system of claim 41, wherein the lens is mounted within the housing.

46. The system of claim 41, wherein the encoded information comprises a pattern having reflecting and non-reflecting components.

47. The system of claim 41, further comprising a second lens operable to focus radiation from the radiation source onto the encoded information.

48. The system of claim 41, further comprising a support element to maintain the encoded information in a proper plane to be read by the system.

49. The system of claim 41, wherein the semiconductor sensor comprises a photodiode.

50. The system of claim 41, wherein the semiconductor sensor comprises a transistor.

51. The system of claim 41, wherein the semiconductor sensor comprises a Darlington transistor.

52. The system of claim 41, wherein the semiconductor sensor comprises a photo integrated circuit.

53. The system of claim 47, wherein the second lens comprises a Cartesian Ovoid lens.

54. A system for reading encoded information, comprising:
a housing having an aperture formed therein;
a light-emitting diode mounted within the housing and operable to emit infrared light through the aperture; and
a semiconductor sensor mounted within the housing and operable to receive infrared light reflected back through the aperture and to generate an electrical signal representative of the infrared light reflected back through.

55. A method for reading encoded information, comprising:
emitting infrared light onto the encoded information;
receiving infrared light that has been reflected by the encoded information; and
producing an electrical signal representative of the received infrared light.

56. The method of claim 55, further comprising focusing the emitted infrared light onto the encoded information.

57. The method of claim 53, further comprising focusing the infrared light that has been reflected by the encoded information onto a detector.
